(19) United States
(12) Patent Application Publication
(10) Pub. No.: US 2014/0027251 A1
(43) Pub. Date: Jan. 30, 2014

(54) MODULE FOR A MODULAR CONVEYOR MAT AND MODULAR CONVEYOR MAT

(71) Applicants: Leonardus Adrianus Catharinus Cornelissen, 's-Gravenzande (NL); Cornelis Hendrik Mijndert Menke, s'Gravenzande (NL)

(72) Inventors: Leonardus Adrianus Catharinus Cornelissen, 's-Gravenzande (NL); Cornelis Hendrik Mijndert Menke, s'Gravenzande (NL)

(21) Appl. No.: 13/990,173

(22) PCT Filed: Nov. 29, 2011
(86) PCT No.: PCT/NL11/50811

§ 371 Date: Oct. 15, 2013

(30) Foreign Application Priority Data
Nov. 30, 2010 (NL) 2005789

(51) Int. Cl. B65G 17/08; B65G 17/40

(52) U.S. Cl. CPC B65G 17/08; B65G 17/40
USPC 198/853

(57) ABSTRACT

A module (1) for a modular conveyor mat (2), comprising a body part (4) extending between two sides transversely to a conveying direction (8), with a top side (5) for carrying products and a lower side (6), wherein the body part at the front side and rear side (7, 8) viewed in conveying direction comprises a series of hinge parts (9) with adjacent receiving spaces (10) successive transversely to the conveying direction, hinge parts and receiving spaces interdigitate with those of similar modules adjacent in conveying direction. Modules are hingedly coupled by hinge pins (12) through hinge bores (11) provided in hinge parts extending trans versely to the conveying direction. A binge part (9′) adjacent a side (3) of the module has a retaining element (13) located in the hinge part (9′) and integrally formed with the hinge part (9′). The retaining element (13) is accessible from the side (3) of the body part (4) for adjustment between a first position (I) in which a hinge pin (12) can pass the hinge bore (11′) of the hinge part and a second position (II) in which a hinge pin (12) cannot pass the hinge bore (11′) of the hinge part (9′). The retaining element (13) has an orientation intersecting the lower and top side (6, 5) of the body part.

The invention relates to a module for a modular conveyor mat, and to a conveyor mat built up from modules.

Such modules and conveyor mats are generally known and are utilized for conveying products.

The known module comprises a body part extending between two sides, transversely to the conveying direction, with a top side for carrying products to be conveyed and a lower side for cooperation with a conveying track. As a rule, the modules are manufactured from plastic material, by means of injection molding. The body part is provided, viewed in the conveying direction at the front and rear side, with a series of hinge parts with adjacent receiving spaces successive transversely to the conveying direction. Hinge parts and receiving spaces can interdigitate with receiving spaces and hinge parts of similar modules adjacent in conveying direction. Modules successive in conveying direction can be hingedly coupled by means of hinge pins reaching through hinge bores provided in the hinge parts and extending transversely to the conveying direction.

Modules successive in conveying direction can be joined for forming a conveyor mat of desired length. As a rule, the conveyor mat is of endless design, so that it can be led over a conveying track by means of return wheels. The width of the mat can be varied by placing several modules side by side transversely to the conveying direction and coupling them with the aid of continuous hinge pins.

The hinge pins should then be secured transversely to the conveying direction relative to the conveyor mat. Although securing can be achieved by providing the hinge pins locally with a thickening, for the sake of manufacture, it is often preferred to design the hinge pins as an extruded pin with a constant cross section, and to provide modules located near the sides of the conveyor mat with a retaining element. Such a retaining element may be designed as a separate part, such as a detachable closing clip or a separately formed closing element that is coupled to the module such that it is adjustable. Such an adjustable retaining element can then be adjusted between a first position, in which it can allow the passage of a hinge pin, and a second position, in which it can block a hinge pin. However, in an advantageous manner, the retaining element is formed integrally with the module. Then, there is no need to manufacture the closing clip separately, to attach it to the module requiring additional handling, and furthermore it cannot detach easily. Further advantages of a closing clip formed integrally with the module are that there is no need to have a separate stock of closing clips in the right numbers, colours and designs.

In EP 0 652 169, a module has been proposed wherein a hinge pin adjacent a side of the module is provided with a retaining element located in the hinge part and integrally formed with the hinge part. The retaining element extends substantially in conveying direction, and can be adjusted via a recess located at the top surface of the body part between a first position in which a hinge pin can pass the hinge bore of the hinge pin, and a second position in which a hinge pin cannot pas a hinge bore of the hinge part. A disadvantage of this solution is, inter alia, that the retaining element is not accessible for handling from a side of the module and can hence be returned to the first position only with difficulty. To that end, in NL 1002501 applicant has proposed a module in which a hinge part adjacent a side of the module is provided with an integrally formed retaining element located in the hinge part and extending substantially in conveying direction. The retaining element is accessible from the side of the body part for adjustment between a first position in which under deformation of the retaining element a hinge pin can pass the hinge bore of the hinge part adjacent the side of the body part, and a second position in which a hinge pin cannot pas the hinge bore of the hinge part.

However, this solution is disadvantageous in that in the first position, the retaining element is located to a small extent within the passage of the hinge bores of the series of hinge parts. As a result, the module cannot be used as central module in a conveyor mat, and for forming a wider conveyor mat, a second type of module not provided with the retaining element must be manufactured.

The object of the invention is to provide a module for a modular conveyor mat with which, while maintaining the advantages mentioned, the disadvantages mentioned can be counteracted. To that end, the invention provides a module for a modular conveyor mat, comprising a body part extending between two sides transversely to the conveying direction with a top side for carrying products to be conveyed and a lower side for cooperation with a conveyor track, wherein the body part comprises, viewed in conveying direction at the front and rear side, a series of hinge parts with adjacent receiving spaces successive transversely to the conveying direction, so that hinge parts and receiving spaces can interdigitate with receiving spaces and hinge parts of similar modules adjacent in conveying direction, and successive modules can be coupled by means of hinge pins extending transversely to the conveying direction and reaching through hinge bores provided in the hinge parts, and wherein a hinge part adjacent a side of the module is provided with a retaining element located in the hinge part and integrally formed with the hinge part, which retaining element is accessible from the side of the body part for adjustment between a first position in which a hinge pin can pass the hinge bore of the hinge part, and a second position in which a hinge pin cannot pas the hinge bore of the hinge part, the retaining element being oriented in an orientation intersecting the lower and top part of the body part. Orientating the retaining element in such an orientation, from the lower to the top side of the body part or in reverse orientation, i.e. in an at least partly upstanding orientation extending at least partly transversely to the conveying direction, allows for the retaining element in the first position to be located less within the passage of the hinge bores of the series of hinge parts, or even to be located outside this passage. When the retaining element is in the first position, it will hinder the hinge pin less or even not at all. As a result, the module with the retaining element accessible from the side can be used in the conveyor mat not only as an edge module but also as a central module. As a result, the conveyor mat can, in principle, be composed with one type of basic module.

By connecting the retaining element to the hinge part via a film hinge, a relatively compact construction can be obtained. This is relevant in particular because with the retaining element in such a slightly upstanding orientation, relatively little space is available for integrating the retaining element in the hinge part. Providing a reduced portion at the location of the film hinge allows for a relatively large deflection of the retaining element.

Providing the retaining element with a stop which cooperates transversely to the conveying direction with a support surface of the hinge part adjacent the hinge bore, can increase the capacity of the retaining element for absorbing forces transversely to the conveying direction. The use of a film hinge in particular can increase the reliability of the construction.

The retaining element can be joined to the body part near the lower or top side of the body part. When the retaining element is connected near the top side of the hinge part, this top side can relatively easily be designed to be substantially closed.

By providing a free end of the retaining element located near the lower side of the body part with a stop projection which cooperates with a receded side surface at the lower side of the hinge part, the module can be manufactured in a cost-effective manner with the aid of a relatively simple injection molding mold.

It is preferred that in the first position, the retaining element is located outside the passage of the hinge bores of the series of hinge parts. The retaining element can then be elegantly provided with a side surface which, in the first position, forms a part of the casing of the hinge bore. As a result, the module with the retaining element in the first position can be very well included in the mat as a central module. This is the case in particular when the hinge bore has a substantially cylindrical outer surface, and the side surface forms a part of the outer surface.

By providing the retaining element with a flexibly disposed back part which, in the second position, cooperates with an edge of the hinge bore, it can be achieved that the retaining element can be secured in the second position.

In an elegant manner, the hinge parts are free at the front and top side from recesses. Designing the hinge parts thus to be closed, the risk of contamination of the module can be reduced, and the module can be prevented from damaging the products to be conveyed, or the retaining element from being inadvertently operated. Thus, also, the products can be transported in a more stable manner, which is particularly relevant when the module is not used as edge module but as central module.

The invention also relates to a modular conveyor mat, comprising a number of rows, successive in conveying direction, of modules adjacent transversely to the conveying direction having one or more of the above-mentioned features, wherein modules successive in conveying direction are hingedly coupled with the aid of hinge pins extending transversely to the conveying direction and wherein the retaining elements of the modules whose side edges form edges of the conveyor mat, are in the second position, while the remaining retaining elements are in the first position.

The invention will be elucidated on the basis of a non-limitative exemplary embodiment which is represented in a drawing. In the drawing:

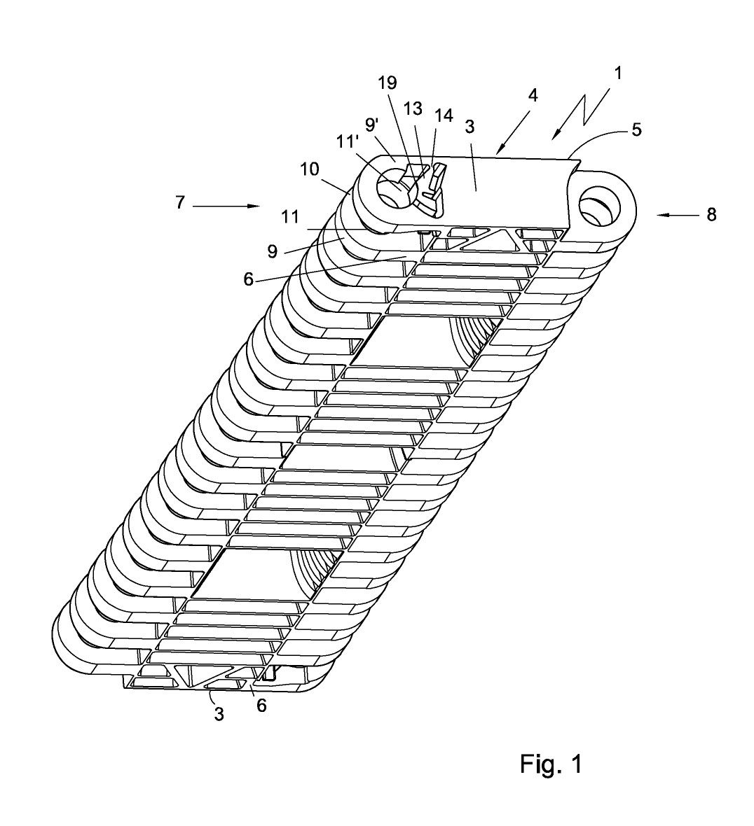

FIG. 1 shows a schematic perspective bottom view of a module for a modular conveyor mat;

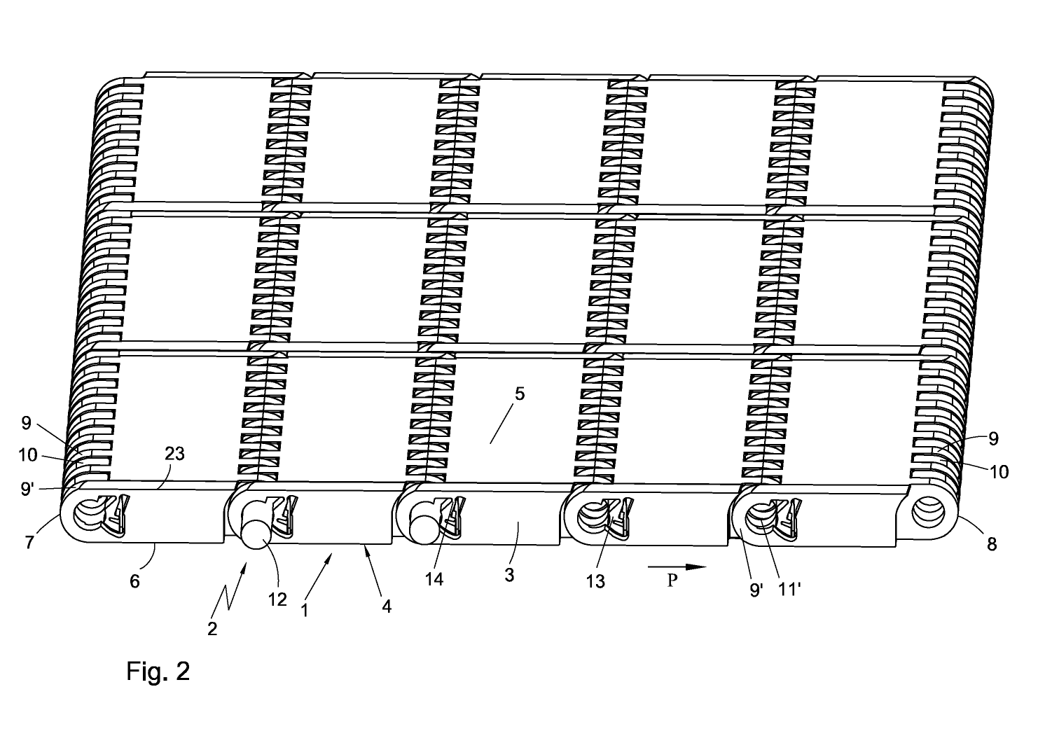

FIG. 2 shows a schematic perspective side view of a modular conveyor mat which is built up with the aid of the modules of FIG. 1;

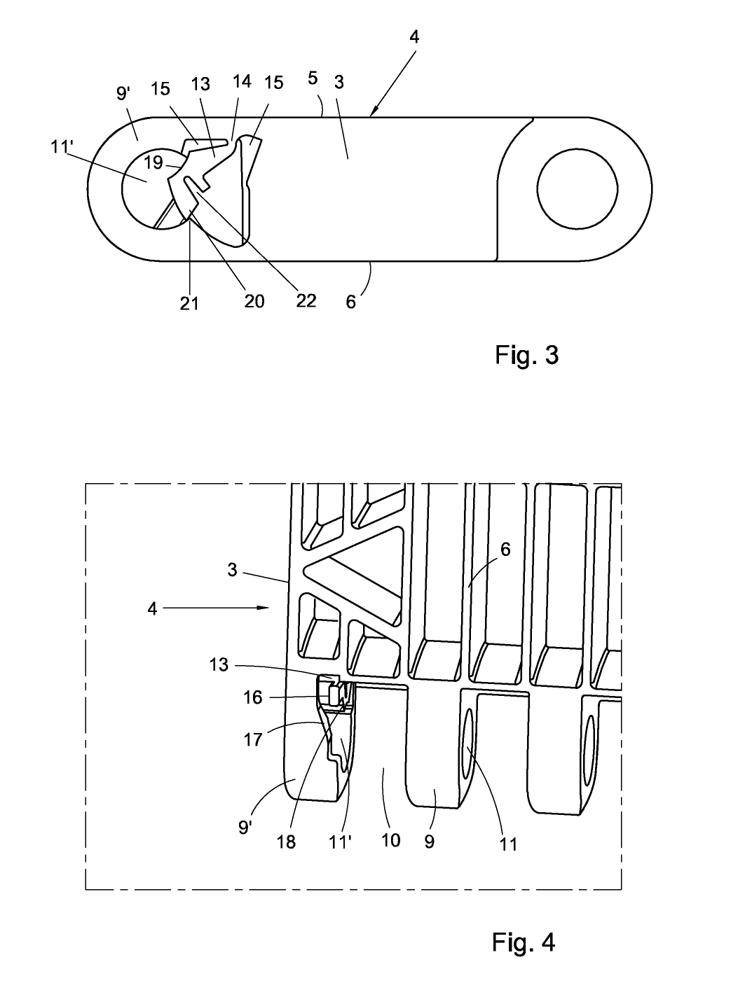

FIG. 3 is a schematic side view of a detail of the module of FIG. 1; and

FIG. 4 is a schematic perspective bottom view of a detail of the module of FIG. 1.

It is noted that the Figures are merely schematic representations of a preferred embodiment of the invention. In the Figures, identical or corresponding parts are represented with the same reference numerals.

FIGS. 1-4 show a module 1 for a modular conveyor mat 2. The module 1 comprises a body part 4 extending transversely to a conveying direction indicated with arrow P. The body part 4 comprises a top side 5 for carrying products to be conveyed, and a lower side 6 for cooperation with a conveyor track (not represented).

The body part 4 is provided at the respective front and rear sides 7, 8 viewed in conveying direction P, with a series of hinge parts 9 with adjacent receiving spaces 10 successive transversely to the conveying direction. As is shown in FIG. 2, hinge parts 9 and receiving spaces 10 can interdigitate with receiving spaces 10 and hinge parts 9 of similar modules 1 adjacent in conveying direction P. In this example, the hinge parts are for instance free of recesses at the front and top side, and therefore have a closed surface.

Modules 1 successive in conveying direction P are hingedly coupled by means of hinge pins 12 reaching through hinge bores 11 provided in the hinge parts and extending transversely to the conveying direction. In this exemplary embodiment, the hinge bores 11 are cylindrical, but alternatively can have a cross section deviating from the cylindrical shape.

The hinge pins 12 can extend transversely to the conveying direction P over the entire width of the modular conveyor mat 2. As an alternative, transversely to the conveying direction P, several hinge pins 12 can be provided which each extend over only a part of the width of the conveyor mat 2. Preferably, the hinge pins 12 are cylindrical with a substantially constant cross section, but can also have a different and/or varying cross section Here, the hinge pins 12 are manufactured from a plastic material that hinges well with the material of the body part 4, which, in this example, is also manufactured from plastic. Suitable plastics are, for instance, polyester or acetal for the modules 1, and polypropylene or polyester for the hinge pins 2. Naturally, other types of material are possible, for instance steel as material for the hinge pins.

A hinge part 9′ adjacent a side 3 of the module 1 is provided with a retaining element 13 located in the hinge part 9′ and integrally formed with the hinge part 9. The retaining element 13 is accessible from the side 3 of the body part 4 to be adjusted between a first position I in which a hinge pin 12 can pass the hinge bore 11′ of the hinge part 9′, and a second position II, in which the hinge pin 12 cannot pass the hinge bore 11′ of the hinge part 9′. The second position is shown in FIG. 3. In the second position, the retaining element 13 reaches into the passage of the hinge bore 11′, i.e., into the recess enclosed by the hinge bore for axial feed-through of the hinge pin 12.

In this exemplary embodiment, the retaining element 13 is designed as a pivotally arranged lip with a specific form with an increasing width. Although the form shown is advantageous, in an alternative embodiment, the retaining element 13 can have a different form, for instance a finger with a substantially constant width. The retaining element 13 extends in an orientation intersecting the lower and top side 6, 5 of the body part. Here, the retaining element is oriented in an orientation directed from the top side 5 towards the lower side 6 of the body part 4. In this example, this is shown both in the first position I shown in FIG. 1 and in the second position II shown in FIG. 3. In both positions therefore, the retaining element does not extend in a lying orientation, but at least partly upstanding. In this exemplary embodiment, the retaining element 13 extends in both positions substantially upstanding, substantially transversely to the conveying direction P.

In FIG. 3 it is shown that the retaining element 13 is connected to the hinge part 9′ via a film hinge 24. At the location of the film hinge 14, a reduced portion 15 is provided so that the retaining element 13 has a relatively large deflection. Naturally, as an alternative, also a relatively thick base can be provided around which the retaining element 13 pivots. In this exemplary embodiment, the retaining element 13 is hingedly connected to the hinge part 9′ via a hinge 14 located near the lower side 6 of the body part 3. As an alternative, the retaining element 13 can for instance be pivotally connected near the top side 5 of the body part 3.

In FIG. 4 it is shown that the retaining element 13 is provided with a stop 16 with cooperates transversely to the conveying direction P with a supporting surface 17 of the hinge part 9′ adjacent the hinge bore 11′. This allows the retaining element to absorb, transversely to the conveying direction, a relatively large force directed towards the side edge 23 of the conveyor mat 2. In particular, a free end 18 of the retaining element 13 located near the lower side 6 of the body part 4 is provided with a stop projection as stop 16 which cooperates with a recessed side surface as supporting surface 17. This configuration can be manufactured by means of two superimposed parts of an injection molding mold, while in the form cavity, except for the retractable pins defining the hinge bores, no further sliding wall parts are required.

In FIG. 1 it is clearly shown that in the first position I, the retaining element 13 is located outside the passage of the hinge bores of the series of hinge parts, so that the hinge pin 12 can pass without deforming the retaining element 13. To this end, the retaining means 13 is provided with a side surface 19 which, in the first position I, forms a part of the casing of the hinge bore 11′. In this example, the retaining element 13 is further provided with a flexibly disposed back part 20 which, in the second position II, cooperates with an edge 21 of the hinge bore 9′.

The retaining element 13 can be adjusted from the side 3 of the module 1 from the first position I to the second position II with the aid of, for instance, the blade of a screw driver. When passing the edge 21, the back part 20 will bounce inward slightly due to the presence of the film hinge 14 and the notch 22 provided in the retaining element near the back part 20. After passing the edge 21, the retaining element 13 will bounce back again, so that thereupon the edge 21 prevents a free return to the first position I and the retaining element remains in the second position II and prevents exiting of a hinge pin 12 via the hinge bore 11′ in that the retaining element 13 is partly located in the passage of the hinge bore 11′. If desired, the retaining element 13 can be pushed back again to the first position I with the blade of the screw driver.

In FIG. 2, it is shown that the modular conveyor mat 2 comprises a number of rows successive in conveying direction of modules adjacent transversely to the conveying direction. Adjacent modules 1 are hingedly coupled by means of hinge pins 12 extending transversely to the conveying direction P. During use, the retaining elements 13 of the modules 1 whose hinge parts 9′ are located at the side edges 23 of the conveyor mat 2 are in the second position II shown in FIG. 3. The remaining retaining elements 13 are in the first position. In particular, the retaining elements 13 of the opposite hinge parts 9 of the modules 1 located at the side edge 23 of the conveyor mat are in the first position I.

The invention is not limited to the exemplary embodiment shown here. In particular the shape of the retaining element can vary. And the orientation of the retaining element in the module can be upstanding to a greater or lesser degree. Further, in modules all hinge parts located at one side can be provided with retaining elements, or only a few of the hinge parts located at one side, or only one. In the conveyor mat, several types of modules can be included, and modules with and without retaining elements can alternate for instance in conveying direction. Further, the shape of the body part and the pattern of the hinge part can vary per module. For instance, a number of hinge parts can be of extra wide design and the corresponding receiving space too. In addition, the hinge parts at the front side and rear side of the module can be opposite each other instead of staggered as is the case in the exemplary embodiment shown. Further, the top surface of the modules can have, instead of a closed design, an at least partly open design and/or the top surface can be provided with cams or carrier parts. These and similar, different variants will be clear to the skilled person, and are understood to fall within the purview of the invention as set forth in the following claims.

### LIST OF REFERENCE NUMERALS

1 module
2 conveyor mat
3 side
4 body part
5 top side
6 lower side
7 front side
8 rear side
9 hinge part/9′ hinge part at side
10 receiving space
11 hinge bore/11′ hinge bore at side
12 hinge pin
13 retaining element
14 hinge
15 reduced portion
16 stop
17 support surface
18 free end
19 side surface
20 back part
21 edge
22 notch
23 side edge conveyor mat
P conveying direction
I first position
II second position

1. A module for a modular conveyor mat, comprising
a body part extending between two ends transversely to a conveying direction and a front side and a rear side viewed in the conveying direction, with a top side for carrying products to be conveyed and a lower side for cooperation with a conveying track;
a series of hinge parts extending from the front side and the rear side of the body part with adjacent receiving spaces successive transversely to the conveying direction, so that hinge parts and receiving spaces can interdigitate with receiving spaces and hinge parts of similar modules adjacent in conveying direction, and modules successive in conveying direction can be hingedly coupled by means of hinge pins reaching through hinge bores provided in the hinge parts and extending transversely to the conveying direction; and
a retaining element located in and integrally formed with a hinge part adjacent to an end of the body part, which retaining element is accessible from the end of the body part for adjustment between a first position in which a hinge pin can pass the hinge bore of the hinge part adjacent to the end of the body part, and a second position in which a hinge pin cannot pass the hinge bore of the hinge part adjacent to the end of the body part, wherein the retaining element is oriented in an orientation intersecting the lower side and top side of the body part.

2. The module according to claim 1, wherein the retaining element is connected to the hinge part via a film hinge.

3. The module according to claim 1, wherein the retaining element is provided with a stop which cooperates transversely to the conveying direction with a supporting surface of the hinge part adjacent the hinge bore.

4. The module according to claims 1, wherein the retaining element is hingedly connected to the hinge part via a hinge located near the top side of the body part.

5. The module according to claims 1, wherein a free end of the retaining element located near the lower side of the body part is provided with a stop projection which cooperates with a receded side surface at a lower side of the hinge part adjacent to the end of the body part.

6. The module according to claims 1, wherein the retaining element in the first position is located outside a passage defined by the hinge bores of the series of hinge parts.

7. The module according to claims 1, wherein the retaining element is provided with a side surface which, in the first position, forms a part of the casing of the hinge bore in the hinge part adjacent to the end of the body part.

8. The module according to claims 1, wherein the retaining element is provided with a flexibly disposed back part which, in the second position, cooperates with an edge of the hinge bore in the hinge part adjacent to the end of the body part.

9. The module according to claims 1, wherein the hinge parts are free from recesses at the front and top sides.

10. A modular conveyor mat, comprising a number of rows successive in conveying direction of modules adjacent transversely to the conveying direction each of the modules having a body part extending between two ends transversely to a conveying direction, with a top side for carrying products to be conveyed and a lower side for cooperation with a conveying track, a series of hinge parts extending from the front side and rear side of the body part with adjacent receiving spaces successive transversely to the conveying direction, so that hinge parts and receiving spaces can interdigitate with receiving spaces and hinge parts of similar modules adjacent in conveying direction, and modules successive in conveying direction can be hingedly coupled by means of hinge pins reaching through hinge bores provided in the hinge parts and extending transversely to the conveying direction, and a retaining element located in and integrally formed with a hinge part adjacent to an end of the body part, which retaining element is accessible from the end of the body part for adjustment between a first position in which a hinge pin can pass the hinge bore of the hinge part adjacent to the end of the body part, and a second position in which a hinge pin cannot pass the hinge bore of the hinge part adjacent to the end of the body part, wherein the retaining element is oriented in an orientation intersecting the lower and top side of the body part, wherein successive modules are hingedly coupled by means of hinge pins extending transversely to the conveying direction and wherein the retaining elements of the modules whose sides form edges of the conveyor mat are in the second position, while the remaining retaining elements are in the first position.
